(19) United States
(12) Patent Application Publication
(10) Pub. No.: US 2020/0027051 A1
(43) Pub. Date: Jan. 23, 2020

(54) SYSTEMS AND METHODS FOR DETERMINING THE STATUS OF LOADING DOCKS AND RESOURCES AT PRODUCT DISTRIBUTION CENTERS

(71) Applicant: Walmart Apollo, LLC, Bentonville, AR (US)

(72) Inventor: Timothy J. Burleson, Bentonville, AR (US)

(21) Appl. No.: 16/510,320

(22) Filed: Jul. 12, 2019

Related U.S. Application Data
(60) Provisional application No. 62/700,986, filed on Jul. 20, 2018.

(51) Int. Cl. G06Q 10/06; G06Q 10/08; G06F 3/0482; B65G 69/28; H04W 4/021; H04W 4/029

(52) U.S. Cl. CPC G06Q 10/06398; G06Q 10/0838; G06Q 10/0833; H04W 4/029; G06F 3/0482; B65G 69/28; H04W 4/021; G06Q 10/087

(57) ABSTRACT

There are provided systems and methods for determining the status of loading docks and resources at product distribution centers. In one form, the system includes: a product distribution center including loading docks for receiving trailers transporting shipments of merchandise, beacons disposed at predetermined locations in the product distribution center, and a mobile device for communication with the beacons to determine the position of the mobile device in the product distribution center relative to the loading docks. In the system, a control circuit receives tracking information from the mobile device to determine the position of the mobile device, determines the use and availability of the loading dock closest to the mobile device; determines the arrival times of trailers, determines the status of resources at or near the closest loading dock, and causes the display of this loading dock and resource information on the mobile device.

### CROSS-REFERENCE TO RELATED APPLICATION

This application claims the benefit of U.S. Provisional Application No. 62/700,986, filed Jul. 20, 2018, which is incorporated by reference in its entirety herein.

### TECHNICAL FIELD

This invention relates generally to product distribution centers and warehouses storing merchandise, and more particularly, to determining the status of loading docks and resources at the product distribution centers and warehouses.

### BACKGROUND

In the retail setting, merchandise is often stored at product distribution centers and warehouses. Shipments are constantly being received at a product distribution center, and merchandise must then be stored at appropriate locations within the product distribution center. Further, merchandise may be constantly shipped from the product distribution center to stores and other locations. Accordingly, one important aspect is to maintain an organized approach regarding the loading docks receiving and transporting the merchandise shipments and regarding the resources available at the product distribution center to handle the shipments.

It is desirable that managers and other supervisory personnel at the product distribution center be able to determine the status of loading docks and resources. Further, the uncontrolled presentation of information regarding loading docks and resources can be overwhelming and unhelpful. It is therefore desirable to present managers and supervisory personnel with relevant information regarding loading docks and resources in an easily comprehendible form.

### BRIEF DESCRIPTION OF THE DRAWINGS

Disclosed herein are embodiments of systems, apparatuses and methods pertaining to determining the status of loading docks and resources at product distribution centers. This description includes drawings, wherein:

FIG. 1 is a schematic diagram in accordance with some embodiments;

FIG. 2 is a block diagram in accordance with some embodiments;

FIG. 3 is a flow diagram in accordance with some embodiments;

FIGS. 4A, 4B, and 4C are screenshots in accordance with some embodiments;

FIGS. 5A, 5B, 5C, 5D, 5E, and 5F are screenshots in accordance with some embodiments; and

FIG. 6 is a block diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for determining the status of loading docks and resources at product distribution centers. In one form, the system comprises: a product distribution center configured to store merchandise and including a plurality of loading docks configured to receive trailers transporting shipments of merchandise; a plurality of beacons disposed at a plurality of predetermined locations in the product distribution center, each beacon configured to transmit a unique signal; and a mobile device with a microcontroller configured for communication with one or more beacons to determine the position of the mobile device in the product distribution center relative to the plurality of loading docks. The system further comprises a control circuit communicatively coupled to the mobile device, the control circuit configured to: receive tracking information from the mobile device based on the device's communication with the one or more beacons to determine the position of the mobile device in the product distribution center; determine the use and availability of the loading dock closest to the mobile device; determine the scheduled or estimated arrival times of trailers with incoming shipments of merchandise at the loading dock closest to the mobile device; determine the status of resources at or near the loading dock closest to the mobile device; and cause to display on the mobile device the use and availability of the loading dock closest to the mobile device, the estimated or scheduled arrival time of trailers at the loading dock closest to the mobile device, and the status of resources at or near the closest loading dock. In the system, the control circuit communicates with the microcontroller to transmit and cause to display local information to the mobile device at a specific area in the product distribution center based on the microcontroller's communication with the one or more beacons.

In some implementations, the system further comprises a virtual geofencing boundary at a predetermined distance about the product distribution center to provide notice of arrival of trailers at the product distribution center. In some implementations, a barcode is disposed at each loading dock and wherein the mobile device is configured to read the barcode at a desired loading dock to determine the use and availability of the desired loading dock. In some implementations, the control circuit is configured to assign a first trailer arriving at the product distribution center within a predetermined amount of time to a loading dock unoccupied by a second trailer. In some implementations, the control circuit is configured to determine and to cause to display on the mobile device, upon request from the mobile device, one or more of: the number of trailers present at the loading docks, the use and availability of the loading docks, the scheduled or estimated times of arrival of trailers, and the status of resources. In some implementations, the control circuit is configured to determine and to cause to display on the mobile device, upon request from the mobile device, the quantity of merchandise delivered to the product distribution center over a predetermined time period. In some implementations, the control circuit is configured to determine and to cause to display on the mobile device, upon request from the mobile device, one or more of: recent attendance of a selected employee at the product distribution center over a predetermined time, the selected employee's start date at his current position, and the selected employee's certifications and training. In some implementations, the control circuit is configured to determine and to cause to display on the mobile device, upon request from the mobile device, audit information of shipments of merchandise received at the product distribution center over a predetermined time period. In some implementations, the control circuit is configured to determine and to cause to display on the mobile device, upon request from the mobile device, the operation of conveyors at or near the closest loading dock

In another form, there is provided a method for determining the status of loading docks and resources at product distribution centers, the method comprising: providing a product distribution center configured to store merchandise and including a plurality of loading docks configured to receive trailers transporting shipments of merchandise; disposing a plurality of beacons at a plurality of predetermined locations in the product distribution center, each beacon configured to transmit a unique signal; and providing a mobile device with a microcontroller configured for communication with one or more beacons to determine the position of the mobile device in the product distribution center relative to the plurality of loading docks. The method further comprises, by a control circuit: receiving tracking information from the mobile device based on the device's communication with the one or more beacons to determine the position of the mobile device in the product distribution center; determining the use and availability of the loading dock closest to the mobile device; determining the scheduled or estimated arrival times of trailers with incoming shipments of merchandise at the loading dock closest to the mobile device; determining the status of resources at or near the loading dock closest to the mobile device; causing to display on the mobile device the use and availability of the loading dock closest to the mobile device, the estimated or scheduled arrival time of trailers at the loading dock closest to the mobile device, and the status of resources at or near the closest loading dock; and communicating with the microcontroller to transmit and cause to display local information to the mobile device at a specific area in the product distribution center based on the microcontroller's communication with the one or more beacons.

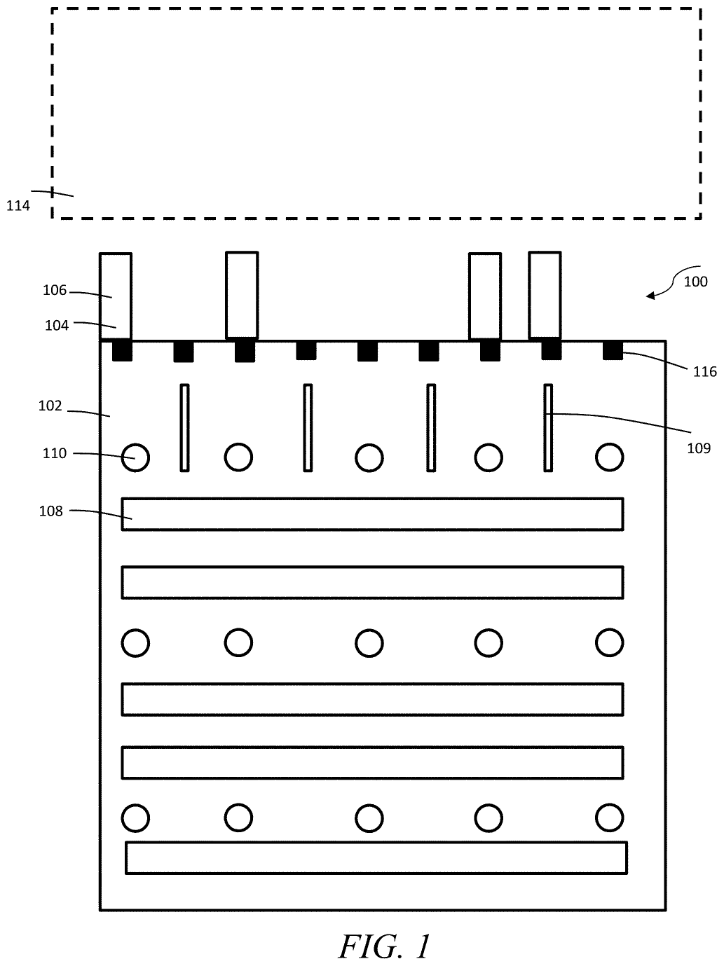

Referring to FIG. 1, there is shown a schematic diagram of a system 100 involving a product distribution center 102. As addressed below, it is generally contemplated that managers and other supervisors will be provided with data regarding loading docks and resources at a merchandise/product distribution center 102. For example, the system 100 allows coordination of delivery trucks/trailers with incoming and outgoing merchandise with personnel who unload or load the trailers. Given, the continual arrival and departure of trailers, it should be understood that an efficient and well-organized approach is desirable to avoid a possible backlog and pile up of merchandise and trailers. In one form, it is generally contemplated that relevant data is presented to the managers, i.e., regarding the nearest loading dock 104, so as not to overwhelm the manager with too much data, although the manager could access additional data, as desired.

The system 100 includes a product distribution center 102 or warehouse for the storage of merchandise. In one form, the product distribution center 102 may be operated by a retailer for the purpose of holding merchandise that may, in turn, be transported to multiple stores. The product distribution center 102 includes loading docks 104 for receiving incoming trailers 106 transporting shipments of merchandise, and the loading docks 104 may also be used for outgoing shipments to stores. In this example, multiple shelving units 108 may be arranged throughout the product distribution center 102 for the storage of merchandise. Further, conveyors 109 may be arranged throughout the product distribution center 102, including near the loading docks 104, to facilitate movement of merchandise about the product distribution center 102. As should be evident, a variety of possible types and arrangements of product distribution centers and warehouses is contemplated.

It is also generally contemplated that a plurality of beacons 110 are disposed at predetermined locations in the product distribution center 102. As addressed further below, these beacons 110 are intended to track the location of the manager within the product distribution center 102 and provide the manager with data about the nearest loading dock and associated resources. It is generally contemplated that these beacons 110 are radio transmitters that transmit signals in a relatively small radius to cover interior spaces. In one form, these beacons 110 are battery-operated, inexpensive, and energy efficient and may use Bluetooth technology. Also, in one form, it is generally contemplated that each beacon 110 transmits a unique signal (i.e., a unique identifier) corresponding to the beacon's position in the product distribution center 102. So, when a specific beacon's signal is received by the manager, the location of the manger within the product distribution center 102 can be determined. Further, as addressed below, the manager's mobile device 112 receiving one or more beacon signals may measure the signal strength for localization and a more specific determination of position. A variety of beacons are available, and any of various types may be used. Moreover, it is generally contemplated that various arrangements of beacons 110 in the product distribution center 102 are possible, such as beacons 110 disposed in some pattern only near the loading docks 104 or beacons 110 disposed at spaced intervals throughout the entire product distribution center 102.

In another form, other types of indoor positioning and tracking systems are also contemplated. Some examples of indoor positioning and tracking techniques include a WiFi Indoor Positioning System (WIPS), Ultra-Wideband (UWB), and Radio Frequency Identification (RFID) (and combinations thereof). WIPS utilizes internet connectivity to determine indoor position based on tracking location sent to and from the network (which may involve the use of beacons 110). Ultra-Wideband (UWB) technologies use radio waves capable of penetrating objects, which may be received by sensors. The manager's mobile device 112 may include a UWB transceiver that communicates with sensors arranged throughout the product distribution center 102. RFID tagging may also be used to determine indoor position by affixing RFID tags throughout the product distribution center 102, such as to pipes, walls, shelving units, etc. The manager's mobile device 112 would be able to read RFID tags, which would provide information on location.

The system 100 also includes a mobile device 112 with a microcontroller configured for communication with one or more beacons 110 to determine the position of the mobile device 112 in the product distribution center 102 relative to the loading docks 104. It is generally contemplated that the manager will carry the mobile device 112 around with him about the product distribution center 102 and that the manager will be able to view data regarding, among other things, loading docks 104 and resources. The mobile device 112 may be any of various types, including without limitation smartphones, handheld tablets, smart glasses (and/or other wearable devices) that can be worn by the manager and display data, etc. Further, as described below, it is generally contemplated that the mobile device 112 may include a downloaded application that will facilitate the collection and display of loading dock and resource data on the manager's mobile device 112.

So, in one form, the system 100 employs beacons 110 to help focus the manager on a specific area in the distribution center 102. This localization is then be used to focus the view of the metrics in the app to those docks 104, doors, resources, etc. that are in the proximity. For example, if the manager proceeds to a particular dock 104, the system 100 might focus the data presented on just the associates working on that dock 104 and the trailer there, etc.

Referring to FIG. 1, there is also shown a virtual geofencing boundary 114. It is generally contemplated that the system 100 may use a virtual geofencing boundary 114 to track the arrival of incoming trailers 106 with merchandise shipments. The virtual geofencing boundary 114 is arranged at a predetermined distance about the product distribution center 102 to provide notice of arrival of an incoming trailer 106 and to provide personnel with a desired amount of time to prepare for the incoming shipment. It is generally contemplated that arriving vendors or other individuals driving the trailers will be equipped with mobile or other devices configured to trigger the geofence when the boundary is crossed, such as by GPS.

In addition, it is generally contemplated that each loading dock 104 includes an interface 116 that facilitates opening and closing of the loading dock doors. In one form, it is contemplated that a barcode may be located at or near the interface 116 of each loading dock 104, and this barcode may provide an alternative means for obtaining information at the loading dock 104. More specifically, a barcode may be disposed at each loading dock 104, and the mobile device 112 may be configured to read the barcode at a desired loading dock 104 to determine the use and availability of that loading dock 104. This alternative, back-up approach might be used, for example, if one or more of the beacons 110 is non-functional, such as if the beacon's battery or power supply is exhausted or interrupted.

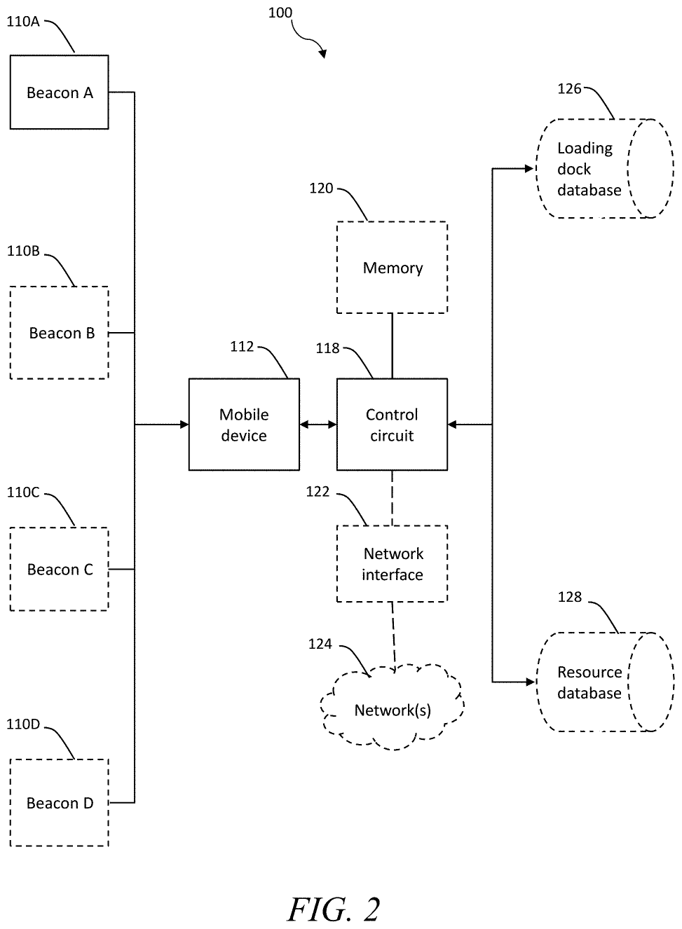

Referring to FIG. 2, the system 100 is shown with certain components that communicate and interact with each other. In this example, the system 100 is shown with four beacons 110: Beacon A (110A), Beacon B (110B), Beacon C (110C), and Beacon D (110D). In one form, these beacons 110 each emit a unique signal (constituting a unique identifier) that is picked up by the mobile device 112 to allow the determination of the mobile device's position in the product distribution center 102. The unique identifier and the signal strength of each beacon 110 may be used to calculate position either by the mobile device or by the control circuit 118. As should be understood, any number of beacons 110 may be used, as desired and appropriate, to provide coverage at desired areas in the product distribution center 102.

The system 100 also includes a control circuit 118 that generally controls the operation of the system 100. Being a “circuit,” the control circuit 118 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 118 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 118 is configured (for example, by using corresponding programming as will be well understood by those skilled in the art) to carry out one or more of the steps, actions, and/or functions described herein.

By one optional approach, the control circuit 118 operably couples to a memory 120. This memory 120 may be integral to the control circuit 118 or can be physically discrete (in whole or in part) from the control circuit 118, as desired. This memory 120 can also be local with respect to the control circuit 118 (where, for example, both share a common circuit board, chassis, power supply, and/or housing) or can be partially or wholly remote with respect to the control circuit 118 (where, for example, the memory 120 is physically located in another facility, metropolitan area, or even country as compared to the control circuit 118).

This memory 120 can serve, for example, to non-transitorily store the computer instructions that, when executed by the control circuit 118, cause the control circuit 118 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the control circuit 118 also operably couples to a network interface 122. So configured, the control circuit 118 can communicate with other elements (both within the system 100 and external thereto) via the network interface 122. Network interfaces, including both wireless and non-wireless platforms, are well understood in the art and require no particular elaboration here. This network interface 122 can compatibly communicate via whatever network or networks 124 may be appropriate to suit the particular needs of a given application setting. The control circuit 118 may be in communication with a server of the product distribution center 102 and may make use of cloud databases and/or operate in conjunction with a cloud computing platform. Both communication networks and network interfaces are well understood areas of prior art endeavor and therefore no further elaboration will be provided here in those regards for the sake of brevity.

In one form, the system 100 may include a loading dock database 126 and/or a resource database 128 (which databases may be coupled to the control circuit 118). The loading dock database 126 may store constantly updated information regarding the loading docks 104, such as, without limitation, the occupancy of each loading dock 104, the scheduled and/or estimated arrival times of trailers 106 at each loading dock 104, the nature of merchandise being delivered to or shipped from a loading dock 104, etc. Similarly, the resource database 128 may store continually updated information regarding resources, such as, without limitation, the status of conveyors 109 at or near the loading docks 104, the status of autonomous ground vehicles and robotic devices that may assist with the unloading (or loading), the use and availability of specific shelving units 108 that may receive merchandise from a loading dock 104, the attendance and qualifications of employees at the product distribution center 102, forklift assignments, etc.

The control circuit 118 is communicatively coupled to the mobile device 112 and transmits data regarding loading docks and resources to the mobile device 112. Initially, the position of the mobile device 112 is determined (and thereby the position of the manager). More specifically, the control circuit 118 receives tracking information from the mobile device 112 based on the device's communication with one or more beacons 110 to determine the position of the mobile device 112 in the product distribution center 102. In one form, the control circuit 118 uses the unique signal/identifier associated with each beacon 110 (and optionally signal strength) to calculate the position of the mobile device 112.

The control circuit 118 determines the use and availability of the loading dock 104 closest to the mobile device 112. In one form, the control circuit 118 may access a loading dock database 126 that contains data regarding the use and availability of the loading docks 104 throughout the product distribution center 102. This loading dock database 126 may show which loading docks 104 are currently occupied by trailers 106 and which loading docks 104 are currently vacant.

The control circuit 118 determines the scheduled or estimated arrival times of trailers with incoming shipments of merchandise at the loading dock 104 closest to the mobile device 112. In one form, the loading dock database 126 may contain data regarding scheduled arrival times of incoming trailers 106 to the product distribution center 102. In addition, or alternatively, the control circuit 118 may receive real time updates of estimated arrival times, which may be provided by geofencing (as addressed above) or which may otherwise be provided by the trailers 106 as they travel toward the product distribution center 102 (such as via GPS).

The control circuit 118 determines the status of resources at or near the loading dock 104 closest to the mobile device 112. For example, as addressed above, these resources may be accessible from a resource database 128. These resources may include such resources as the status of conveyors 109 at or near the loading docks 104, the status of autonomous ground vehicles and robotic devices that may assist with the unloading (or loading), the use and availability of specific shelving units 108 that may receive merchandise from a loading dock 104, and the attendance and qualifications of employees at the product distribution center 102.

The control circuit 118 then causes the display of this information on the mobile device 112. More specifically, the control circuit 118 causes the display of the use and availability of the loading dock 104 closest to the mobile device 112, the estimated or scheduled arrival time of trailers 106 at the loading dock 104 closest to the mobile device 112, and the status of resources at or near the closest loading dock 104. Accordingly, the control circuit 118 communicates with the microcontroller of the mobile device 112 to transmit and cause to display local information to the mobile device 112 at a specific area in the product distribution center 102 based on the microcontroller's communication with the one or more beacons 110. The control circuit 118 preferably displays relevant, local information, rather than an overwhelming amount of possibly irrelevant information.

The system 100 may optionally use an artificial intelligence or machine learning approach to make straightforward decisions (thereby freeing the manager to handle more complex decisions). For example, a machine learning approach might allow the control circuit 118 to assign a trailer arriving at the product distribution center 102 within a certain amount of time to a loading dock 104 unoccupied by any trailers. As should be evident, in one form, the control circuit 118 might simply randomly assign an incoming trailer 106 to an unoccupied loading dock 104. However, alternatively, in another form, the system 100 may use a supervised learning approach in which it infers weights to be given to inputted factors based on several examples (such as based on past assignment decisions by a manager). Each example includes a set of inputs (i.e., unoccupied loading docks, type of merchandise on the incoming trailer, operability/run times of conveyors 109, etc.) and a known output value (i.e., unoccupied loading dock 104 closest to shelving units 108 storing the arriving type of merchandise, assuming operable conveyors 109). A supervised learning algorithm analyzes the examples (or past inputs and corresponding outputs) and generates an inferred function, which can be used to predict new examples (i.e., to predict an output based on new inputs). In this form, the supervised learning approach may employ a training session with illustrative examples during which inputs based on various factors are compared to the actual output. Assignment of trailers is just one example of a decision amenable to machine learning, and it may be applied to other decision making as well.

In addition, it is contemplated that the mobile device 112 will be able to access more detailed information (even if that is not the local data that is automatically displayed on the mobile device 112). As a first example, the mobile device 112 may access and display global information at the product distribution center 102. In other words, the control circuit 118 may be configured to determine and to cause to display on the mobile device 112, upon request from the mobile device 112, one or more of: the number of trailers 106 present at any of the loading docks 104, the use and availability of any of the loading docks 104, and the scheduled or estimated times of arrival of trailers 106 at all loading docks 104, and the status of resources. As a second example, the mobile device 112 may access and display the productivity at the product distribution center 102. In other words, in one form, the control circuit 118 may be configured to determine and to cause to display on the mobile device 112, upon request from the mobile device 112, the quantity of merchandise delivered to the product distribution center 102 over a predetermined time period. As a third example, the mobile device 112 may access and display detailed resource information. For example, in one form regarding employees, the control circuit 118 may be configured to determine and to cause to display on the mobile device 112, upon request from the mobile device 112, one or more of: recent attendance of a selected employee at the product distribution center 102 over a predetermined time, the selected employee's start date at his current position, and the selected employee's certifications and training. As a fourth example, the mobile device 112 may access and display detailed audit information. In other words, the control circuit 118 may be configured to determine and to cause to display on the mobile device 112, upon request from the mobile device 112, audit information relating to shipments of merchandise received at the product distribution center 102 over a predetermined time period. As a fifth example, the mobile device 112 may access and display information regarding conveyor operation and/or run times. For example, the control circuit 118 may be configured to determine and to cause to display on the mobile device 112, upon request from the mobile device 112, the operation of conveyors at or near the closest loading dock (or globally, conveyor operation throughout the product distribution center 102).

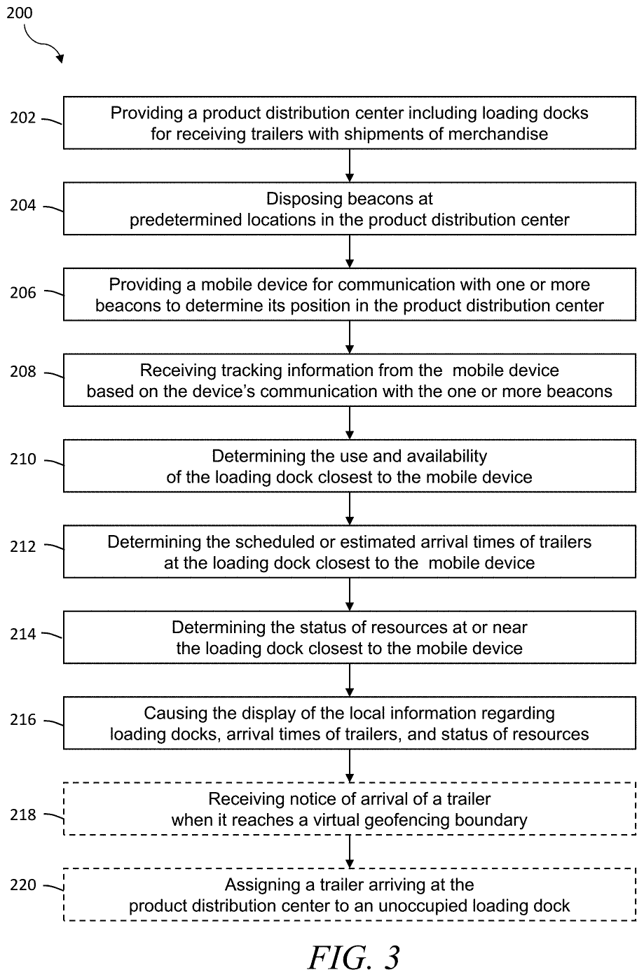

Referring to FIG. 3, there is shown a process 200 for determining the status of loading docks and resources at product distribution centers. It is generally contemplated that tracking beacons are arranged in a predetermined pattern in the product distribution center and that local information regarding loading docks and resources is transmitted to a mobile device whose position is determined. The process 200 may use some or all of the components of the system 100 described above.

At block 202, a product distribution center is provided that includes loading docks for receiving trailers with incoming shipments of merchandise. The product distribution center may also transport stored merchandise to shopping facilities. Any of various types of product distribution centers and warehouses for the storage of merchandise may be used.

At block 204, beacons are disposed at predetermined locations about the product distribution center. The beacons may be any of various types, but it is generally contemplated that each beacon transmits a unique signal (i.e., a unique identifier) corresponding to the beacon's position in the product distribution center 102. When a specific beacon's signal is received by the mobile device, the location of the mobile device within the product distribution center can be determined. Signal strength may also be used to provide a more accurate determination of position. The beacons may be arranged in any pattern to provide the desired coverage, such as throughout the entire product distribution center or clustered in the areas about the loading docks.

At block 206, a mobile device is provided. As addressed above, the mobile device communicates with one or more beacons to determine its position in the product distribution center. At block 208, tracking information from the mobile device is received based on the device's communication with the one or more beacons. In one form, it is generally contemplated that the mobile device's position within the product distribution center may be calculated by the mobile device or by a control circuit (which may be in communication with a server of the product distribution center). Once the position of the mobile device is determined, local information can be transmitted to and displayed at the mobile device.

At block 210, the use and availability of the loading dock closest to the mobile device is determined. At block 212, the scheduled or estimated arrival times of trailers at the loading dock closest to the mobile device are determined. In one form, this information may be stored in a loading dock database that is constantly updated with new information. Also, the estimated arrival times of the trailers may be real time estimates transmitted by the trailers themselves (such as via the use of GPS).

At block 214, the status of resources at or near the loading dock closest to the mobile device is determined. The status of resources may be stored in a resources database and may include such information as, without limitation, the status of conveyors at or near the loading docks, the status of autonomous ground vehicles and robotic devices that may assist with the unloading (or loading), the use and availability of specific shelving units that may receive merchandise from a loading dock 104, and the attendance and qualifications of employees at the product distribution center 102. At block 216, the local information regarding the loading docks, arrival times of trailers, and status of resources is displayed.

The steps of process 200 may occur in various different sequences and may involve additional optional steps. For example, at block 218, notice of arrival of a trailer may optionally be received when the trailer reaches a virtual geofencing boundary. This notice may give the personnel at the product distribution center additional time to prepare for the arrival of the incoming shipment of merchandise. As another example, at block 220, a trailer arriving at the product distribution center is assigned to an unoccupied loading dock. In one form, it is generally contemplated that this assignment decision may be made via artificial intelligence and machine learning taking into account a set of predetermined factors.

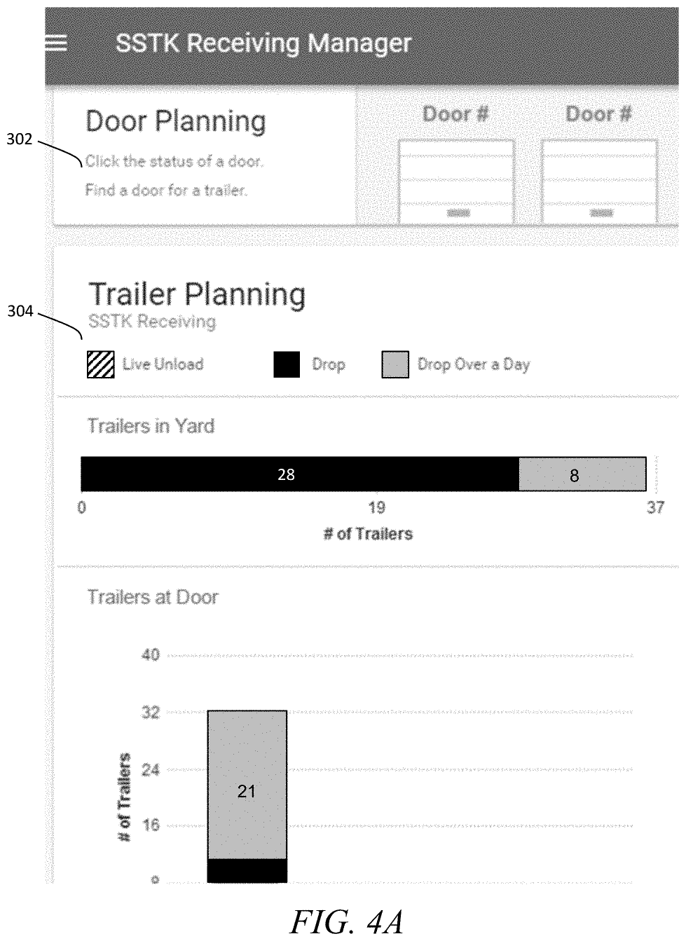

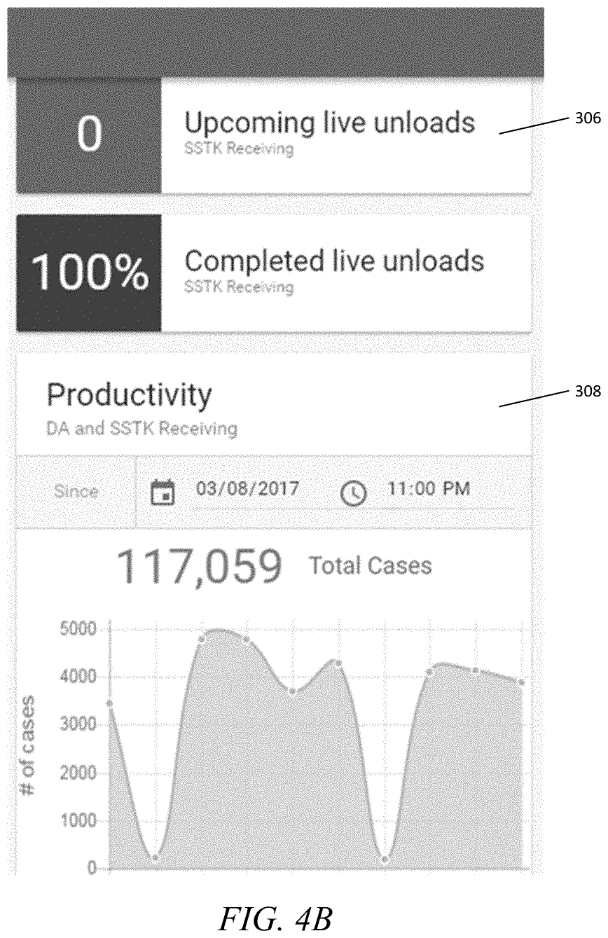

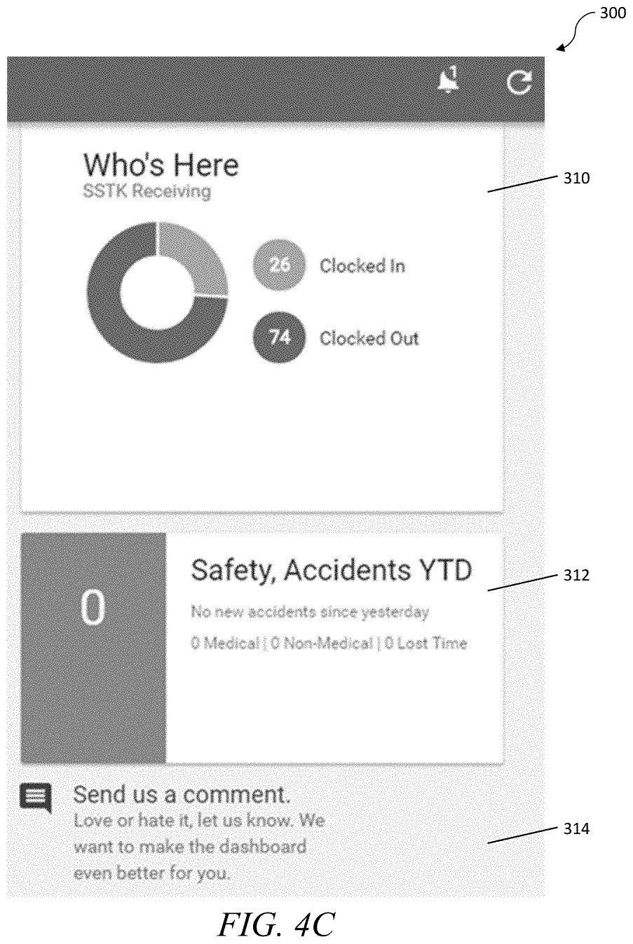

FIGS. 4A-C, 5A-F, and 6 show examples of dashboard displays of the information at the mobile device 112. In these particular examples, the dashboard displays are intended for the receiving department at the product distribution center. It is generally contemplated that these dashboards can, at a minimum, display the use and availability of the loading dock 104 closest to the mobile device 112, the estimated or scheduled arrival time of trailers 106 at the loading dock 104 closest to the mobile device 112, and the status of resources at or near the closest loading dock 104. In addition, it is also contemplated that the user/manager can access additional information, upon request, including but not limited to global information regarding the number of trailers 106 present at the loading docks 104, the use and availability of the loading docks 104, the scheduled or estimated times of arrival of trailers 106, and the status of resources; the quantity of merchandise delivered to and/or shipped from the product distribution center 102 over a predetermined time period; the recent attendance of a selected employee at the product distribution center over a predetermined time, the selected employee's start date at his current position, and the selected employee's certifications and training; audit information relating to shipments of merchandise received at the product distribution center 102 over a predetermined time period; and the operation of conveyors and other equipment at the product distribution center 102. Additionally, the dashboard may alter the displayed items based upon the context, such as based on who is operating the mobile device 112 (functional responsibility) and the time of day. The dashboard may also learn which tiles the user interacts with and may remove unused tiles.

FIGS. 4A-C collectively show a first example of a dashboard 300 displaying some of this information for the receiving department at the product distribution center. In this example, these figures are intended to form one dashboard display with, from the user's viewpoint, FIG. 4A being on the left of the display, FIG. 4B being in the middle of the display, and FIG. 4C being on the right of the display. FIGS. 4A, 4B, 4C are shown separately so as to better illustrate the details in the dashboard 300.

At the “Door Planning” area 302, the manager can click on one or more doors to determine the door's availability for a trailer. At the “Trailer Planning” area 304, the dashboard 300 may display the total number of trailers that are in the yard, that are arriving, and that are at the loading dock door, and the amounts may be color coded to indicate their status. At the “Live Unloads” area 306, the dashboard 300 may display the completion status of the trailers being unloaded. At the “Productivity” area 308, the dashboard 300 may display the total number of cases of merchandise received over a certain interval of time and may provide a graph showing the amounts received over a certain time period. At the “Who's Here” resources area 310, the dashboard 300 may display the employees who are currently in attendance and possibly available to assist with loading or unloading. The manager/user may be able to click on this resources area 310 to access additional attributes and characteristics of employees, such as, for example, certifications, cross-training, attendance/punctuality, start dates at their current positions, etc. The dashboard 300 also includes a “Safety” area 312 showing the accidents year-to-date and a “Comments” area 314 regarding the dashboard 300.

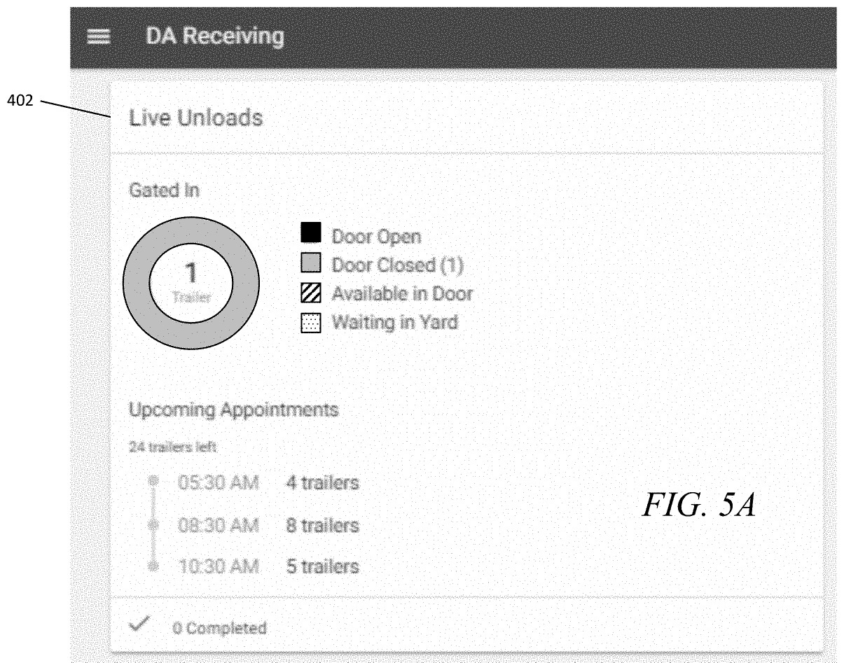

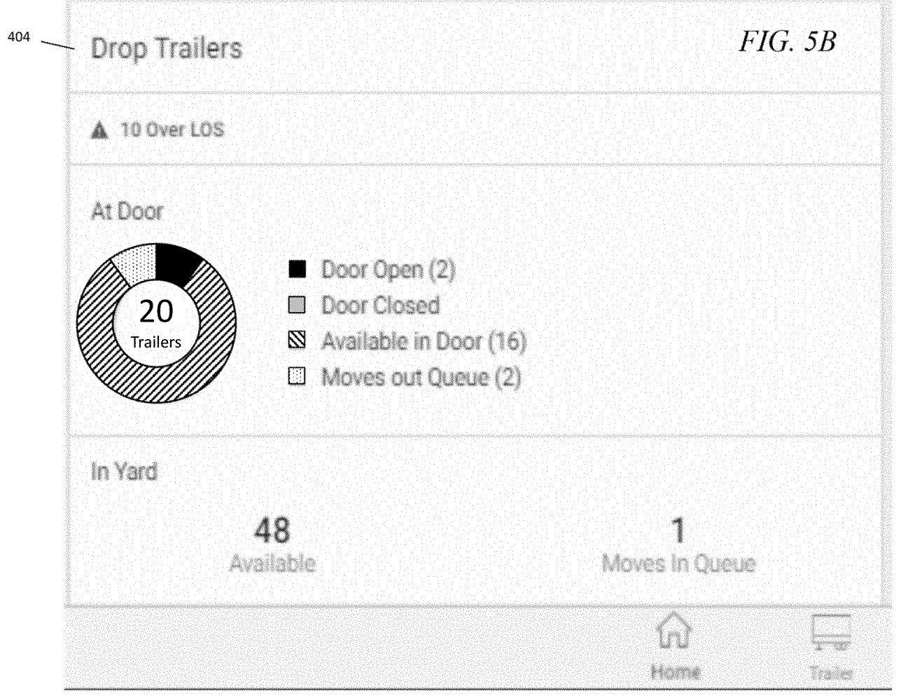

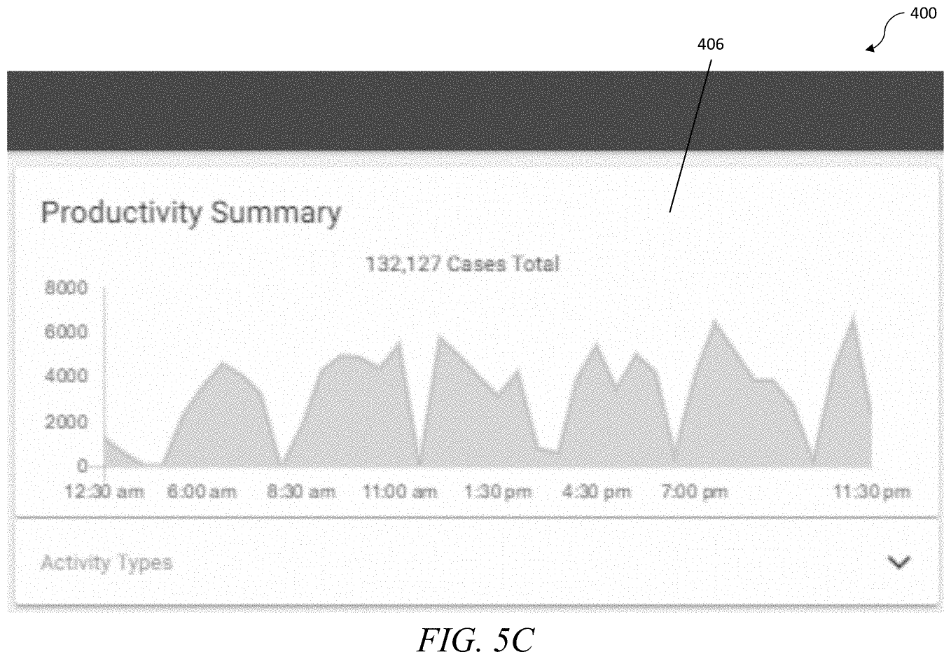

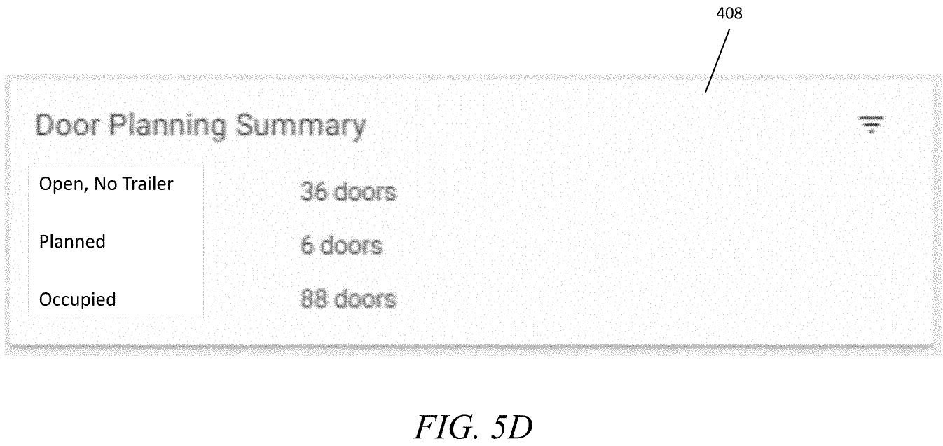

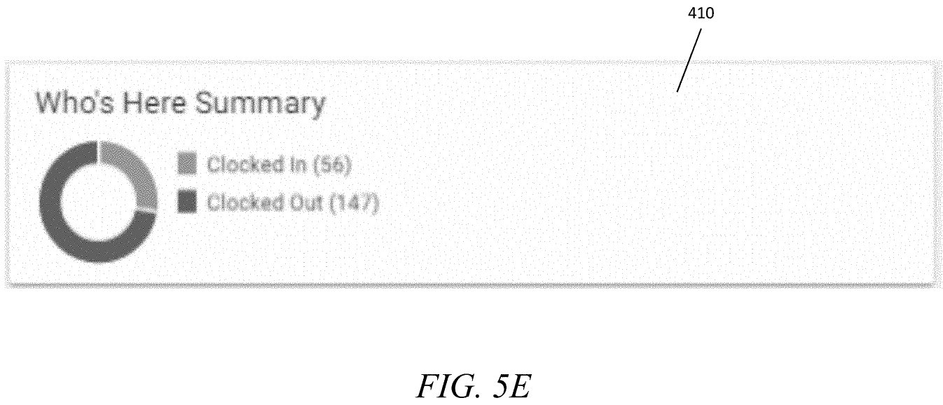

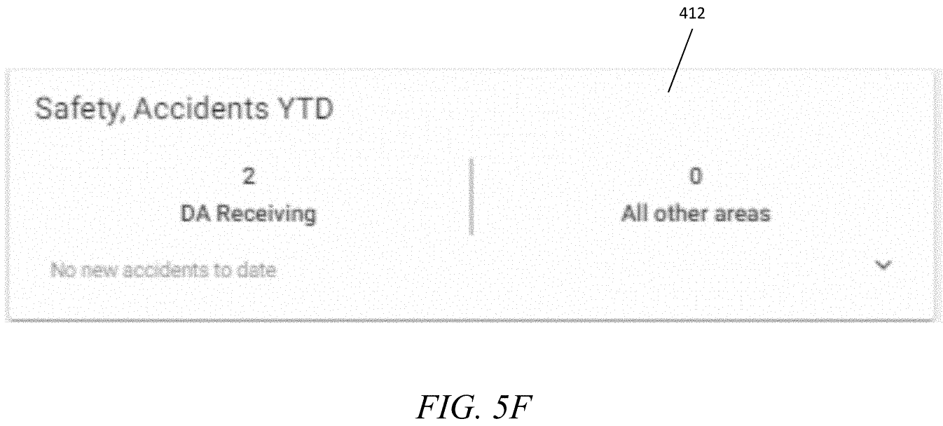

FIGS. 5A-F collectively show a second example of a dashboard 400 displaying information that is similar to the dashboard 300 of FIG. 4. In this example, these figures are intended to form one dashboard display with, from the user's viewpoint, the figures being in the following positions: FIG. 5A (upper left), FIG. 5B (lower left), FIG. 5C (uppermost right), FIG. 5D (intermediate upper right), FIG. 5E (intermediate lower right), and FIG. 5F (lowermost right). FIGS. 5A, 5B, 5C, 5D, 5E, and 5F are shown separately so as to better illustrate the details in the dashboard 400.

At the “Live Unloads” area 402, the dashboard 400 shows the number of trailers that are “gated in” and the status of the trailers and the loading dock doors. Further, it shows upcoming appointments for incoming trailers. At the “Drop Trailers” area 404, the dashboard 400 shows the trailers that have been dropped off in the yard where the vendors may be expected to return in a few days to pick up the unloaded trailers. In this area, the dashboard 400 shows the number of these trailers that are at the loading dock door, the status of the doors, and the trailers in the yard. At the “Productivity Summary” area 406, the dashboard 400 shows the total number of merchandise cases received and graphically shows the amounts received during the course of the day. At the “Door Planning Summary” area 408, the status of the doors is shown (open—with no trailer, planned—reserved for a trailer, and occupied). At the “Who's Here Summary” 410, the number of employees present/absent is displayed, and at the “Safety” area 412, the number of accidents year-to-date is shown.

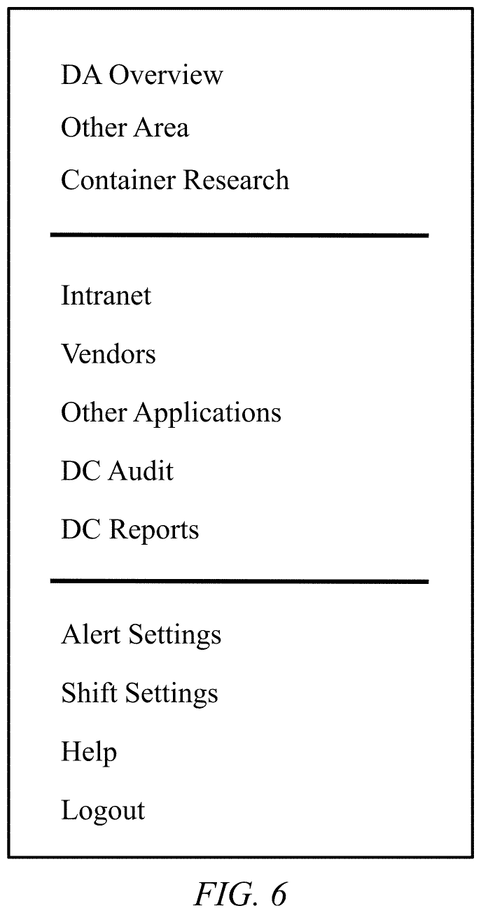

FIG. 6 shows an example of a menu 500 allowing the user to drill down and get more detailed information at the product distribution center 102. It is generally contemplated that this menu can be accessed from the dashboards 300 and 400 to allow the user/manager to request and access more detailed information. The menu 500 generally allows the user/manager to toggle between the dashboards 300 and 400 for the receiving department at the product distribution center (DA overview) and links to other topics/options. For example, these topics and options may include, without limitation: other areas (status, metrics, and information regarding other departments in the product distribution center (DC)); container research (the mobile device allows the scanning or inputting of container/carton labels, thereby accessing information regarding the container and merchandise in the container, such as nature, source, destination, etc.); intranet (internal policies, procedures, and web forms for the company); vendors (information regarding the suppliers making shipments to the distribution center); other applications (other software apps commonly used by the manager); DC audit (summaries of audits such as regarding the quantity of merchandise identified as being shipped versus the actual amount counted upon receipt at the distribution center); DC reports (various reports such as regarding damage to merchandise shipped, missing merchandise, damaged or missing container labels, etc.); alert settings (notifications); shift settings (shift times and area goals); help; and logout.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for determining the status of loading docks and resources at product distribution centers, the system comprising:
a product distribution center configured to store merchandise and including a plurality of loading docks configured to receive trailers transporting shipments of merchandise;
a plurality of beacons disposed at a plurality of predetermined locations in the product distribution center, each beacon configured to transmit a unique signal;
a mobile device with a microcontroller configured for communication with one or more beacons to determine the position of the mobile device in the product distribution center relative to the plurality of loading docks;
a control circuit communicatively coupled to the mobile device, the control circuit configured to:
receive tracking information from the mobile device based on the device's communication with the one or more beacons to determine the position of the mobile device in the product distribution center;
determine the use and availability of the loading dock closest to the mobile device;
determine the scheduled or estimated arrival times of trailers with incoming shipments of merchandise at the loading dock closest to the mobile device;
determine the status of resources at or near the loading dock closest to the mobile device;
cause to display on the mobile device the use and availability of the loading dock closest to the mobile device, the estimated or scheduled arrival time of trailers at the loading dock closest to the mobile device, and the status of resources at or near the closest loading dock;
wherein the control circuit communicates with the microcontroller to transmit and cause to display local information to the mobile device at a specific area in the product distribution center based on the microcontroller's communication with the one or more beacons.

2. The system of claim 1, further comprising a virtual geofencing boundary at a predetermined distance about the product distribution center to provide notice of arrival of trailers at the product distribution center.

3. The system of claim 1, wherein a barcode is disposed at each loading dock and wherein the mobile device is configured to read the barcode at a desired loading dock to determine the use and availability of the desired loading dock.

4. The system of claim 1, wherein the control circuit is configured to assign a first trailer arriving at the product distribution center within a predetermined amount of time to a loading dock unoccupied by a second trailer.

5. The system of claim 1, wherein the control circuit is configured to determine and to cause to display on the mobile device, upon request from the mobile device, one or more of: the number of trailers present at the loading docks, the use and availability of the loading docks, the scheduled or estimated times of arrival of trailers, and the status of resources.

6. The system of claim 1, wherein the control circuit is configured to determine and to cause to display on the mobile device, upon request from the mobile device, the quantity of merchandise delivered to the product distribution center over a predetermined time period.

7. The system of claim 1, wherein the control circuit is configured to determine and to cause to display on the mobile device, upon request from the mobile device, one or more of: recent attendance of a selected employee at the product distribution center over a predetermined time, the selected employee's start date at his current position, and the selected employee's certifications and training.

8. The system of claim 1, wherein the control circuit is configured to determine and to cause to display on the mobile device, upon request from the mobile device, audit information of shipments of merchandise received at the product distribution center over a predetermined time period.

9. The system of claim 1, wherein the control circuit is configured to determine and to cause to display on the mobile device, upon request from the mobile device, the operation of conveyors at or near the closest loading dock.

10. A method for determining the status of loading docks and resources at product distribution centers, the method comprising:
providing a product distribution center configured to store merchandise and including a plurality of loading docks configured to receive trailers transporting shipments of merchandise;
disposing a plurality of beacons at a plurality of predetermined locations in the product distribution center, each beacon configured to transmit a unique signal;
providing a mobile device with a microcontroller configured for communication with one or more beacons to determine the position of the mobile device in the product distribution center relative to the plurality of loading docks;
by a control circuit:
receiving tracking information from the mobile device based on the device's communication with the one or more beacons to determine the position of the mobile device in the product distribution center;
determining the use and availability of the loading dock closest to the mobile device;
determining the scheduled or estimated arrival times of trailers with incoming shipments of merchandise at the loading dock closest to the mobile device;
determining the status of resources at or near the loading dock closest to the mobile device;
causing to display on the mobile device the use and availability of the loading dock closest to the mobile device, the estimated or scheduled arrival time of trailers at the loading dock closest to the mobile device, and the status of resources at or near the closest loading dock; and
communicating with the microcontroller to transmit and cause to display local information to the mobile device at a specific area in the product distribution center based on the microcontroller's communication with the one or more beacons.

11. The method of claim 10, further comprising, by a virtual geofencing boundary at a predetermined distance about the product distribution center, providing notice of arrival of trailers at the product distribution center.

12. The method of claim 10, wherein a barcode is disposed at each loading dock and wherein the mobile device is configured to read the barcode at a desired loading dock to determine the use and availability of the desired loading dock.

13. The method of claim 10, further comprising, by the control circuit, assigning a first trailer arriving at the product distribution center within a predetermined amount of time to a loading dock unoccupied by a second trailer.

14. The method of claim 10, further comprising, by the control circuit, determining and causing to display on the mobile device, upon request from the mobile device, one or more of: the number of trailers present at the loading docks, the use and availability of the loading docks, the scheduled or estimated times of arrival of trailers, and the status of resources.

15. The method of claim 10, further comprising, by the control circuit, determining and causing to display on the mobile device, upon request from the mobile device, the quantity of merchandise delivered to the product distribution center over a predetermined time period.

16. The method of claim 10, further comprising, by the control circuit, determining and causing to display on the mobile device, upon request from the mobile device, one or more of: recent attendance of a selected employee at the product distribution center over a predetermined time, the selected employee's start date at his current position, and the selected employee's certifications and training.

17. The method of claim 10, further comprising, by the control circuit, determining and causing to display on the mobile device, upon request from the mobile device, audit information of shipments of merchandise received at the product distribution center over a predetermined time period.

18. The method of claim 10, further comprising, by the control circuit, determining and causing to display on the mobile device, upon request from the mobile device, the operation of conveyors at or near the closest loading dock.
